(19) United States
(12) Patent Application Publication
(10) Pub. No.: US 2012/0183878 A1
(43) Pub. Date: Jul. 19, 2012

(54) Manufacturing Method Of Electrode Catalyst Layer, Electrode Catalyst Layer, Membrane Electrode Assembly And Fuel Cell

(76) Inventors: Saori Okada, Tokyo (JP); Haruna Kurata, Tokyo (JP); Hiroyuki Morioka, Tokyo (JP); Kenichiro Oota, Kanagawa (JP)

(21) Appl. No.: 13/431,936

(22) Filed: Mar. 27, 2012

Related U.S. Application Data
(63) Continuation of application No. PCT/JP2010/054377, filed on Mar. 16, 2010.

(30) Foreign Application Priority Data
Sep. 29, 2009 (JP) 2009-224465

(51) Int. Cl. H01M 8/10; H01M 4/88; H01M 4/90; H01M 4/96; H01M 4/86

(52) U.S. Cl. 429/480; 429/479; 429/485; 429/484; 427/115

(57) ABSTRACT

The present invention provides an electrode catalyst layer and a manufacturing method thereof, wherein the electrode catalyst layer contains an oxide type of non-platinum catalyst as the catalyst and enables a fuel cell employing the electrode catalyst layer to achieve a high level of power generation performance, as well as an MEA and the fuel cell which employ the electrode catalyst layer. The manufacturing method of the electrode catalyst layer of the present invention includes preparing a “catalyst provided with electrical conductivity on the surface”. In addition, the manufacturing method may further include preparing a catalyst ink, in which the “catalyst provided with electrical conductivity on the surface”, carbon particles and a polymer electrolyte are dispersed in a solvent, and coating the catalyst ink to form the electrode catalyst layer.

This application is a continuation of International Application No. PCT/JP2010/054377, filed Mar. 16, 2010, which is incorporated herein by reference in its entirety.

### BACKGROUND OF THE INVENTION

1. Field of the Invention

The present invention relates to a manufacturing method of an electrode catalyst layer, the electrode catalyst layer, a membrane electrode assembly (MEA) which includes the electrode catalyst layer, and a fuel cell which includes the electrode catalyst layer. More specifically, the present invention relates to a manufacturing method of an electrode catalyst layer which has high power generation performance using a non-platinum catalyst, the electrode catalyst layer, an MEA which includes the electrode catalyst layer, and a fuel cell which includes such an electrode catalyst layer.

3. Description of the Related Art

A fuel cell is a power generation system which produces electric power along with heat. A fuel gas including hydrogen and an oxidant gas including oxygen react together at electrodes containing a catalyst in a fuel cell so that a reverse reaction of water electrolysis takes place. A fuel cell is attracting attention as a clean energy source of the future because of advantages such as high efficiency, a small impact on the environment and a low level of noise relative to conventional power generation systems. A fuel cell is classified into several types according to an ion conductor employed therein. A fuel cell which uses a proton-conductive polymer membrane is called a proton exchange membrane fuel cell (PEMFC) or a polymer electrolyte fuel cell (PEFC).

Among various fuel cells, a PEMFC (or PEFC), which can be used at around room temperature, is regarded as a promising fuel cell for use in vehicles and household stationary power supply etc. and is being developed widely in recent years. In the PEMFC (or PEFC), a joint unit which has a pair of electrode catalyst layers on both sides of a polymer electrolyte membrane and is called a membrane electrode assembly (MEA) is arranged between a pair of separators, on each of which either a gas flow path for supplying a fuel gas including hydrogen to one of the electrodes or a gas flow path for supplying an oxidant gas including oxygen to the other electrode is formed. The electrode for supplying a fuel gas is called a fuel electrode or anode whereas the electrode for supplying an oxidant gas is called an air electrode or cathode. In general, each of these electrodes includes an electrode catalyst layer, in which a polymer electrolyte(s) and catalyst loaded carbon particles loaded are stacked, and a gas diffusion layer which has gas permeability and electrical conductivity. A noble metal etc. such as platinum is used as the catalyst.

Apart from other problems such as improving durability and output density etc., cost reduction is the most major problem for putting the PEMFC (or PEFC) into practical use.

Since the PEMFC (or PEFC) at present employs expensive platinum as the electrode catalyst, an alternate catalyst is strongly desired to fully promote the PEMFC (or PEFC). As more platinum is used in the air electrode than in the fuel electrode, an alternative to platinum (namely, a non-platinum catalyst) with a high level of catalytic performance for oxygen-reduction on the air electrode is particularly well under development.

A mixture of a noble metal and nitride of iron (a transition metal) described in Patent document 1 is an example of a non-platinum catalyst for the air electrode. In addition, a nitride of molybdenum (a transition metal) described in Patent document 2 is another example. These catalyst materials, however, have an insufficient catalytic performance for oxygen-reduction in an acidic electrolyte and are dissolved in some cases.

On the other hand, Non-patent document 1 reports that a partially-oxidized tantalum carbonitride has both excellent stability and catalytic performance. It is true that this oxide type non-platinum catalyst has a high level of catalytic performance for oxygen-reduction in itself but the catalyst is not loaded on carbon particles unlike a platinum catalyst and it remains necessary to find an appropriate method to make the catalyst surface conductive because the catalyst has poor electrical conductivity.

Moreover, Patent document 3 describes an MEA employing a non-platinum catalyst. In Patent document 3, however, there is such a problem that a method to make the non-platinum catalyst into an electrode catalyst layer is not suitable for a non-platinum catalyst since it is a method which is described, for example, in Patent document 4 and Patent document 5 etc. and is conventionally used for platinum catalyst.

<Patent document 1>: JP-A-2005-44659.

<Patent document 2>: JP-A-2005-63677.

<Patent document 3>: JP-A-2008-270176.

<Patent document 4>: JP-B-H02-48632 (JP-A-H01-62489).

<Patent document 5>: JP-A-H05-36418.

<Non-patent document 1>: “Journal of The Electrochemical Society”, Vol.155, No. 4, pp. B400-B406 (2008).

### SUMMARY OF THE INVENTION

The present invention provides a manufacturing method of an electrode catalyst layer which has a high level of power generation performance using an oxide type of non-platinum catalyst as a catalyst material.

After eager research to solve various problems, the inventors completed the present invention.

A first aspect of the present invention is a manufacturing method of an electrode catalyst layer for a fuel cell including: (1) preparing a “catalyst provided with electrical conductivity” by coating a first conductive material(s) on a surface of a catalyst, (2) preparing a catalyst ink by dispersing the “catalyst provided with electrical conductivity”, a second conductive material(s) and a polymer electrolyte in a solvent, and (3) coating the catalyst ink on a substrate to form the electrode catalyst layer, wherein the substrate is one of the group of a gas diffusion layer, a transfer sheet and a polymer electrolyte membrane.

A second aspect of the present invention is the manufacturing method according to the first aspect of the present invention, wherein the first conductive material(s) in (1) is a conductive polymer.

A third aspect of the present invention is the manufacturing method according to the second aspect of the present invention, wherein a weight ratio of the first conductive material(s) with respect to 1 of the catalyst is in the range of 0.01-30 in (1)

A fourth aspect of the present invention is the manufacturing method according to the third aspect of the present invention, wherein the dispersion of the “catalyst provided with electrical conductivity”, a second conductive material(s) and a polymer electrolyte in a solvent in (2) is performed in such a way that carbon particles as the second conductive material(s) and the “catalyst provided with electrical conductivity” are preliminarily mixed without any solvent before the polymer electrolyte and the solvent are further added to prepare the catalyst ink.

A fifth aspect of the present invention is the manufacturing method according to the fourth aspect of the present invention, wherein the catalyst contains at least one transition metal of the group of Ta, Nb, Ti and Zr.

A sixth aspect of the present invention is the manufacturing method according to the fifth aspect of the present invention, wherein the catalyst is a product made by partially-oxidizing a carbonitride of one transition metal of the group of Ta, Nb, Ti and Zr in the presence of oxygen.

A seventh aspect of the present invention is the manufacturing method according to the sixth aspect of the present invention, wherein the one transition metal is Ta.

An eighth aspect of the present invention is an electrode catalyst layer for a fuel cell including: a catalyst, a second conductive material(s), and a polymer electrolyte, wherein a first conductive material(s) is coated on at least a part of a surface of the catalyst.

A ninth aspect of the present invention is the electrode catalyst layer according to the eighth aspect of the present invention, wherein the first conductive material(s) is a conductive polymer and the second conductive material(s) is carbon particles.

A tenth aspect of the present invention is the electrode catalyst layer according to the ninth aspect of the present invention, wherein a weight ratio of the first conductive material(s) with respect to 1 of the catalyst is in the range of 0.01-30.

An eleventh aspect of the present invention is the electrode catalyst layer according to the tenth aspect of the present invention, wherein the catalyst contains at least one transition metal of the group of Ta, Nb, Ti and Zr.

A twelfth aspect of the present invention is the electrode catalyst layer according to the eleventh aspect of the present invention, wherein the catalyst is a product made by partially-oxidizing a carbonitride of one transition metal of the group of Ta, Nb, Ti and Zr in the presence of oxygen.

A thirteenth aspect of the present invention is the electrode catalyst layer according to the twelfth aspect of the present invention, wherein the one transition metal is Ta.

A fourteenth aspect of the present invention is a membrane electrode assembly including: a polymer electrolyte membrane, a pair of electrode catalyst layers, and a pair of gas diffusion layers, wherein each of the pair of electrode catalyst layers is the electrode catalyst layer according to the thirteenth aspect of the present invention, and wherein the polymer electrolyte membrane is interposed between the pair of electrode catalyst layers and the pair of electrode catalyst layers are interposed between the pair of gas diffusion layers.

A fifteenth aspect of the present invention is a fuel cell including: the membrane electrode assembly according to the fourteenth aspect of the present invention, and a pair of separators, wherein the membrane electrode assembly is interposed between the pair of separators.

According to the present invention, a catalyst in an electrode catalyst layer which contains the catalyst, a conductive material(s) and a polymer electrolyte is provided with conductivity on the surface so that conductivity of the electrode catalyst layer is improved. As a result, active reaction sites in the electrode catalyst layer are increased and an MEA and a fuel cell which have improved output performance are obtained.

### BRIEF DESCRIPTION OF THE DRAWINGS

FIG. 1 is a cross sectional exemplary diagram of an MEA of the present invention.

FIG. 2 is an exploded exemplary diagram of a fuel cell of the present invention.

### DESCRIPTION OF NUMERALS

1: Polymer electrolyte membrane

2: Electrode catalyst layer

3: Electrode catalyst layer

12: Membrane electrode assembly (MEA)

4: Gas diffusion layer

5: Gas diffusion layer

6: Air electrode (Cathode)

7: Fuel electrode (Anode)

8: Gas flow path

9: Cooling water flow path

10: Separator

### EMBODIMENT OF THE INVENTION

An MEA of an embodiment of the present invention is described below. Embodiments of the present invention are not fully limited to the embodiment of the present invention described below since the embodiment can be modified, redesigned, changed, and/or added with details etc. according to any knowledge of a person in the art so that the scope of the embodiment of the present invention is expanded.

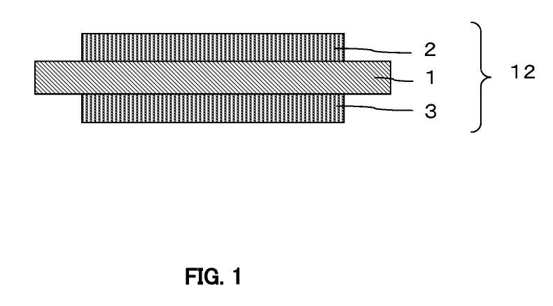

FIG. 1 illustrates a concise cross section diagram of the MEA 12 of the embodiment of the present invention. The MEA 12 of the embodiment of the present invention has a polymer electrolyte membrane 1, an electrode catalyst layer (for a cathode) 2 on a surface of the polymer electrolyte membrane 1, and an electrode catalyst layer (for an anode) 3 on the other surface of the polymer electrolyte membrane 1, as is shown in FIG. 1.

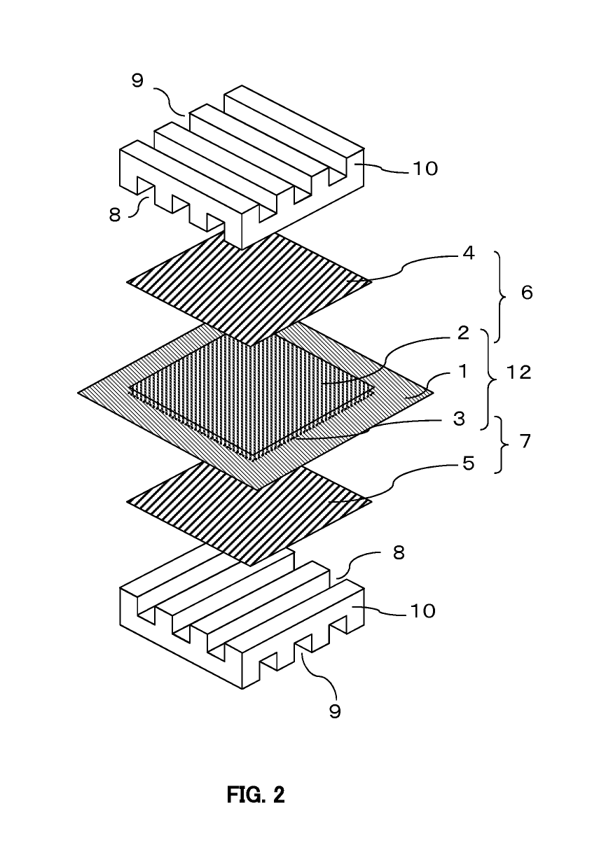

FIG. 2 illustrates an exploded exemplary diagram of a fuel cell of an embodiment of the present invention. In the fuel cell, a gas diffusion layer (for the cathode) 4 and a gas diffusion layer (for the anode) 5 are arranged facing the electrode catalyst layer 2 and electrode catalyst layer 3, respectively. These are structures of an air electrode (the cathode) 6 and a fuel electrode (the anode) 7. Moreover, a pair of separators 10 is arranged in the fuel cell, wherein each separator 10 is made of a conductive and impermeable material and has a gas flow path 8 for transporting a gas on one surface and a cooling water path 9 for transporting cooling water on the opposite surface. A fuel gas such as hydrogen gas for example, is supplied through the gas flow path 8 on the separator 10 of the fuel electrode 7 whereas an oxidant gas such as a gas containing oxygen for example, is supplied through the gas flow path 8 on the separator 10 of the air electrode 6. Then, an electromotive force is generated between the fuel electrode 7 and the air electrode 6 by an electrode reaction between hydrogen as the fuel gas and the oxygen gas under the presence of the catalyst.

The fuel cell illustrated in FIG. 2 is one of a so-called “unit cell” structured fuel cell, in which the polymer electrolyte membrane 1, the electrode catalyst layers 2 and 3, and the gas diffusion layers 4 and 5 are interposed between the pair of separators 10, while the present invention also includes a fuel cell in which a plurality of unit cells are stacked via the separator 10.

According to a manufacturing method of an electrode catalyst layer of the present invention, the electrolyte catalyst layer contains a catalyst, a conductive material(s) (referred to as a second conductive material(s)) and a polymer electrolyte, and a surface of the catalyst is provided with conductivity by a method such as coating a conductive material(s) (referred to as a first conductive material(s)) etc. so that conductivity of the electrode catalyst layer is improved. As a result, active reaction sites in the electrode catalyst layer are increased, and it is possible to obtain an MEA and a fuel cell with a high level of output performance by employing the electrode catalyst layer. A conductive polymer and/or carbon particles etc. are preferably used as the first conductive material(s).

In the manufacturing method of the electrode catalyst layer of the present invention, it is possible to employ a method of coating a conductive polymer on the catalyst surface by applying a mechanical energy on the catalyst and the conductive polymer for the purpose of providing the surface of the catalyst with conductivity. For example, it is possible to apply the mechanical energy by mixing the catalyst and the conductive polymer using a ball mill. The coating of the conductive polymer on the catalyst surface may be performed so that the entire surface of the catalyst is completely coated and may also be performed so that some area of the surface is left uncoated as long as conductivity on the catalyst surface is sufficiently improved.

Polymers of, for example, a polyethylenedioxythiophene (PEDOT), a polydioxythiophene, a polythiophen, a polyisothianaphthene (PITN), a polyaniline and a polypyrrole etc. can be used as the conductive polymer of the embodiment of the present invention. It is preferable that the conductive polymer is a polymer which is soluble to water or a water-like solvent such as a polymer of a polyethylenedioxythiophene (PEDOT), a polydioxythiophene, a polythiophen, a polyisothianaphthene (PITN) and a polyaniline.

It is preferable that content ratio by weight of the conductive polymer is in the range of 0.01-30 with respect to 1 of the catalyst. It is more preferable that it is in the range of 0.01-10. In the case where it is lower than 0.01, it is impossible to sufficiently coat the conductive polymer on the catalyst surface. On the other hand, in the case where it is higher than 30, an excessive conductive polymer fills up fine pores on the electrode catalyst layer resulting in a decrease of gas diffusion.

It is also possible to coat the conductive polymer on the catalyst in such a way that a monomer is preliminarily coated on the surface of the catalyst, and then the monomer is polymerized to transform into the conductive polymer coating on the catalyst surface. Conventional polymerization methods such as thermal polymerization and oxidative polymerization by a catalyst etc. can be used as the polymerization method.

In the manufacturing method of the electrode catalyst layer of the present invention, it is also possible to employ a method of coating the carbon particles on the catalyst surface by applying a mechanical energy on the catalyst and the carbon particles for the purpose of providing a surface of the catalyst with conductivity. The coating of the carbon particles on the catalyst surface may be performed so that the entire surface of the catalyst is completely coated and may also be performed so that some area of the surface is left uncoated as long as conductivity of the catalyst surface is sufficiently improved.

Any carbons which are in the shape of particles, electrically conductive and unreactive with the catalyst can be used as the carbon particles related to the embodiment of the present invention. For example, carbon blacks, graphites, black leads, active carbons, carbon fibers, carbon nano-tubes and fullerenes can be used. It is preferable that the carbon particles have a particle diameter in the range of about 10-1000 nm, which is smaller than that of the catalyst, so that it is possible to coat the catalyst with carbon particles.

It is possible to use a generally-used catalyst material as the catalyst of the embodiment of the present invention. It is preferably possible in the present invention to use a positive electrode active material of PEMFC which contains at least one transition metal selected from the group of Ta, Nb, Tl and Zr, as an alternative to platinum in the air electrode.

In addition, it is preferably possible to use a carbonitride of these transition metals which is partially oxidized in an atmosphere including oxygen as the catalyst.

Specifically, a material obtained by partial oxidation of tantalum carbonitride (TaCN), that is TaCNO, which has a specific surface area in the range of about 1-20 m²/g is included in such carbonitrides.

The MEA and the fuel cell of the present invention are described in detail below.

Any material having proton conductivity may be used as the polymer electrolyte membrane 1 in the membrane electrode assembly 12 of the embodiment of the present invention. For example, a fluorine-based polymer electrolyte and a hydrocarbon-based polymer electrolyte can be used. Examples of the fluorine-based polymer electrolyte are Nafion® (made by Du Pont), Flemion® (made by ASAHI GLASS CO., LTD.), Aciplex® (made by Asahi KASEI Cooperation), and Gore Select® (by Japan Gore-Tex Inc.) etc. Examples of the hydrocarbon-based polymer electrolyte are an electrolyte of sulfonated polyether ketone, sulfonated polyether sulfone, sulfonated polyether ether sulfone, sulfonated polysulfide, and sulfonated polyphenylene etc. Among others, materials of Nafion® series made by Du Pont can preferably be used as the polymer electrolyte membrane 1.

Any material having proton conductivity may be used as a polymer electrolyte contained in a catalyst ink (described in detail later) related to the embodiment of the present invention, and fluorine-based polymer electrolytes and hydrocarbon-based polymer electrolytes similar to those of the polymer electrolyte membrane 1 can be used. For example, materials of Nafion® series made by Du Pont etc. can be used as the fluorine-based polymer electrolyte. Electrolytes of sulfonated polyether ketone, sulfonated polyether sulfone, sulfonated polyether ether sulfone, sulfonated polysulfide, and sulfonated polyphenylene etc. can be used as the hydrocarbon-based polymer electrolyte. Among others, materials of Nafion® series made by Du Pont can preferably be used as the polymer electrolyte. It is preferable that the same material used as the polymer electrolyte membrane 1 is employed in consideration of adhesion between the electrode catalyst layer 2 or 3 and the polymer electrolyte membrane 1.

A solvent in which the polymer electrolyte is dissolved with high fluidity or dispersed as a fine gel and yet in which the catalyst and the polymer electrolyte do not corrade can be used as a solvent of the catalyst ink. It is preferable that the solvent contains at least one volatile organic solvent. Alcohols such as methanol, ethanol, 1-propanol, 2-propanol, 1-butanol, 2-butanol, isobutyl alcohol, tert-butyl alcohol and pentanol etc., ketone solvents such as acetone, methyl ethyl ketone, pentanone, methyl isobutyl ketone, heptanone, cyclohexanone, methyl cyclohexanone, acetonyl acetone and diisobutyl ketone etc., ether solvents such as tetrahydrofuran, dioxane, diethylene glycol dimethyl ether, anisole, methoxytoluene and dibutyl ether etc., and other polar solvents such as dimethylformamide, dimethylacetamide, N-methylpyrrolidone, ethylene glycol, diethylene glycol, diacetone alcohol and 1-methoxy-2-propanol etc. are often used although the solvent is not limited to these. In addition, any solvent mixture of a combination of a plurality of these solvents may also be used as the solvent.

In addition, solvents of a lower alcohol have a high risk of igniting. When using one of such solvents, a mixture with water is preferably used as the solvent since water which is highly soluble in the polymer electrolyte can be contained without serious problems. There is no particular limitation to a water additive amount unless the polymer electrolyte is separated from the solvent to generate white turbidity or turn into a gel.

In the manufacturing method of the electrode catalyst layer related to the present invention, a catalyst ink in which the “catalyst provided with conductivity on the surface”, the second conductive material(s) and the polymer electrolyte are dispersed in a solvent is prepared. In preparation of the catalyst ink, it is preferable that the “catalyst provided with conductivity on the surface” and the second conductive material(s) are preliminarily mixed together without any solvent before they are dispersed in the solvent together with the electrolyte. It is possible to strongly combine powers of the “catalyst provided with conductivity on the surface” and the second conductive material(s) by a mechanochemical effect by mixing them together without solvent. Examples of the second conductive material(s) are a conductive polymer and/or carbon particles etc. similar to the first conductive material(s). Carbon particles are particularly preferable.

A dispersant may be contained in the catalyst ink in order to disperse the catalyst and/or the carbon particles. An anion surfactant, a cation surfactant, an amphoteric (or ampholytic) surfactant and a non-ionic surfactant etc. can be used as the dispersant.

Specifically, for example, carboxylate type surfactants such as alkyl ether carbonates, ether carbonates, alkanoyl sarcosines, alkanoyl glutaninates, acyl glutaninates, oleic acid N-methyltaurine, potassium oleate diethanolamine salts, alkyl ether sulfate triethanolamine salts, polyoxyethylene alkyl ether sulfate triethanolamine salts, amine salts of specialty modified polyether ester acids, amine salts of higher fatty acid derivatives, amine salts of specialty modified polyester acids, amine salts of large molecular weight polyether ester acids, amine salts of specialty modified phosphate esters, amideamine salts of large molecular weight polyether ester acids, amide-amine salts of specialty aliphatic acid derivatives, alkylamine salts of higher fatty acids, amide-amine salts of large molecular weight polycarboxylic acids, sodium laurate, and sodium stearate, sodium oleate etc., sulfonate type surfactants such as dialkylsulfosuccinates, salts of 1,2-bis(alkoxycarbonyl)-1-ethanesulfonic acid, alkylsulfonates, paraffin sulfonates, alpha-olefin sulfonates, linear alkylbenzene sulfonates, alkylbenzene sulfonates, polynaphthylmethane sulfonates, naphthalenesulfonate-formaline condensates, alkylnaphthalene sulfonates, alkanoylmethyl taurides, sodium salt of lauryl sulfate ester, sodium salt of cetyl sulfate ester, sodium salt of stearyl sulfate ester, sodium salt of oleyl sulfate ester, lauryl ether sulfate ester salt, sodium alkylbenzene sulfonates, and oil-soluble alkylbenzene sulfonates etc., sulfate ester type surfactants such as alkylsulfate ester salts, alkyl sulphates, alkyl ether sulphates, polyoxyethylene alkyl ether sulfates, alkyl polyethoxy sulfates, polyglycol ether sulfates, alkyl polyoxyethylene sulfates, sulfonate oil, and highly sulfonated oil etc., phosphate ester type surfactants such as monoalkyl phosphates, dialkyl phosphates, monoalkyl phosphate esters, dialkyl phosphate esters, alkyl polyoxyethylene phosphates, alkyl ether phosphates, alkyl polyethoxy phosphates, polyoxyethylene alkyl ethers, alkylphenyl polyoxyethylene phosphate, alkylphenyl ether phosphates, alkylphenyl polyethoxy phosphates, polyoxyethylene alkylphenylether phosphates, disodium salts of higher alcohol phosphate monoester, disodium salts of higher alcohol phosphate diester, and zinc dialkyl dithiophosphate etc. can be used as the anion surfactant mentioned above.

For example, benzyldimethyl [2-{2-(p-1,1,3,3-tetramethylbutylphenoxy)ethoxy}ethyl] ammonium chloride, octadecylamine acetate, tetradecylamine acetate, octadecyltrimethylammonium chloride, beef tallow trimethylammonium chloride, dodecyltrimethylammonium chloride, palm trimethylammonium chloride, hexadecyltrimethylammonium chloride, behenyltrimethylammonium chloride, palm dimethylbenzylammonium chloride, tetradecyldimethylbenzylammonium chloride, octadecyldimethylbenzylammonium chloride, dioleyldimethylammonium chloride, 1-hydroxyethyl-2-beef tallow imidazoline quaternary salt, 2-heptadecenyl-hydroxyethyl imidazoline, stearamideethyldiethylamine acetate, stearamideethyldiethylamine hydrochloride, triethanolamine monostearate formate, alkylpyridium salts, higher alkylamine-ethylene oxide adducts, polyacrylamide amine salts, modified polyacrylamide amine salts, and perfluoroalkyl quaternary ammonium iodide etc. can be used as the cation surfactant stated above.

For example, dimethyl cocobetaine, dimethyl lauryl betaine, sodium laurylaminoethyl glycine, sodium laurylaminopropionate, stearyl dimethyl betaine, lauryl dihydroxyethyl betaine, amide betaine, imidazolinium betaine, lecithin, sodium 3-(ω-fluoroalkanoyl-N-ethylamino)-1-propane sulfonate, and N-{3-(perfluorooctanesulfoneamide)propyl}-N,N-dimethyl-N-carboxymethylene ammonium betaine etc. can be used as the zwitterionic surfactant mentioned above.

For example, coconut fatty acid diethanolamide (1:2 type), coconut fatty acid diethanolamide (1:1 type), beef tallowate diethanolamide (1:2 type), beef tallowate diethanolamide (1:1 type), oleic acid diethanolamide (1:1 type), hydroxyethyl laurylamine, polyethylene glycol laurylamine, polyethylene glycol cocoamine, polyethylene glycol stearylamine, polyethylene glycol beef tallow amine, polyethylene glycol beef tallow propylenediamine, polyethylene glycol dioleylamine, dimethyllaurylamine oxide, dimethylstearylamine oxide, dihydroxyethyllaurylamine oxide, perfluoroalkylamine oxides, polyvinylpyrrolidone, higher alcohol-ethylene oxide adducts, alkyl phenol-ethylene oxide adducts, fatty acid-ethylene oxide adducts, propylene glycol-ethylene oxide adduct, fatty acid esters of glycerin, fatty acid esters of pentaerithritol, fatty acid esters of sorbitol, fatty acid esters of sorbitan, and fatty acid esters of sugar etc. can be used as the nonionic surfactant mentioned above.

Among these, sulfonate type of anion surfactants such as alkylbenzene sulfonic acids, oil soluble alkylbenzene sulfonic acids, α-olefin sulfonic acids, sodium alkylbenzene sulfonates, oil soluble alkylbenzene sulfonates, and α-olefin sulfonates are preferable considering aspects such as dispersing effect for carbons and influence of residual dispersant on catalyst performance.

The catalyst ink receives a dispersion treatment if necessary. Particle-size and viscosity of the catalyst ink can be controlled by a condition of the dispersion treatment. It is possible to perform the dispersion treatment by various types of equipment. Treatments by a ball mill, a roll mill, a shear mill and a wet type mill, and an ultrasonic dispersion treatment etc. are examples. Alternatively, a homogenizer that performs agitation by a centrifugal force may be used in the dispersion treatment.

It is preferable that the amount of solid content in the catalyst ink is in the range of 1-50% by weight. In the case where the amount of solid content is excessively large, cracks tend to be easily created on a surface of the electrode catalyst layer since the viscosity of the catalyst ink is too high. On the other hand, in the case where the amount of solid content is too small, a forming rate of the catalyst layer becomes too low to ensure reasonable productivity. The catalyst, the carbon particles and the polymer electrolyte are included in the solid content. The one containing a higher amount of the carbon particles has higher viscosity, and vice versa when comparing the catalyst inks containing the same amounts of the solid content. Hence, it is preferable that a ratio of the carbon particles with respect to a total solid content is appropriately adjusted within the range of 10-80% by weight. At this time, it is preferable that the viscosity of the catalyst ink is in the range of 0.1-500 cP, and more preferable in the range of 5-100 cP. In addition, a dispersant may be added to the catalyst ink in order to control the viscosity when dispersing the solid content therein.

In addition, the catalyst ink may include a pore forming agent. Fine pores are created by removing the pore forming agent after the electrode catalyst is formed. Examples of the pore forming agent are materials soluble in acid, alkali or water, sublimation materials such as camphor, and materials which decompose by heat. If the pore former is soluble in warm water, it can be removed by water produced during the power generation.

Inorganic salts (soluble to acid) such as calcium carbonate, barium carbonate, magnesium carbonate, magnesium sulfate, and magnesium oxide etc., inorganic salts (soluble to alkali aqueous solution) such as alumina, silica gel, and silica sol etc., metals (soluble to acid and/or alkali) such as aluminum, zinc, tin, nickel, and iron etc., inorganic salts (soluble to water) aqueous solutions of sodium chloride, potassium chloride, ammonium chloride, sodium carbonate, sodium sulfate, and monobasic sodium phosphate etc., and water soluble organic compounds such as polyvinyl alcohol, and polyethylene glycol etc. are available as the pore forming agent soluble in acid, alkali or water. Not only a single material but a plurality of these together can be effectively used.

In the manufacturing method of the electrode catalyst layer related to the present invention, the catalyst ink is coated on the substrate and dried to form the electrode catalyst layer. In the case where a gas diffusion layer or a transfer sheet is used as the substrate, the electrode catalyst layer is transferred to and combined with each of both surfaces of the polymer electrolyte membrane. In addition, in an MEA related to the present invention, it is also possible to use a polymer electrolyte membrane as the substrate, coat the catalyst ink directly on both surfaces of the polymer electrolyte membrane and directly form the electrode catalyst layers on the polymer electrolyte membrane.

At this time, a doctor blade method, a dipping method, a screen printing method, a roll coating method and a spray method etc. can be used as the coating method. Among these, the spray method such as, for example, a pressure spray method, an ultrasonic spray method, and an electrostatic spray method etc. has an advantage that agglutination hardly occurs when drying the coated catalyst ink so that a homogenized and highly porous electrode catalyst layer is obtained.

A gas diffusion layer, a transfer sheet or a polymer electrolyte membrane can be used as the substrate in the manufacturing method of the electrode catalyst layer related to the present invention.

The transfer sheet which is used as the substrate is principally made of a material having good transfer properties. For example, fluororesins such as ethylene tetrafluoroethylene copolymer (ETFE), tetrafluoroethylene hexafluoroethylene copolymer (FEP), tetrafluoroethylene perfluoroalkyl vinyl ether copolymer (PFA), and polytetrafluoroethylene (PTFE) etc. can be used. In addition, polymer sheets or polymer films such as polyimide, polyethylene terephthalate (PET), polyamide (nylon), polysulfone (PSF), polyethersulfone (PES), polyphenylene sulfide (PPS), polyether ether ketone (PEEK), polyetherimide (PEI), polyarylate (PAR), and polyethylene naphthalate (PEN) etc. can be used as the transfer sheet. In the case where such a transfer sheet is used as the substrate, it is possible to peel off and remove the transfer sheet after an electrode catalyst layer is stuck to the polymer electrolyte membrane so as to make an MEA in which electrode catalyst layers are arranged on both sides of the polymer electrolyte membrane.

A material having gas diffusion properties and electric conductivity can be used as a gas diffusion layer. Specifically, a carbon cloth, a carbon paper and a porous carbon such as unwoven carbon fabric can be used as the gas diffusion layer. Such a gas diffusion layer can also be used as the substrate. In the case where a gas diffusion layer is used as the substrate, it is unnecessary to peel off the substrate which acts as the gas diffusion layer after the electrode catalyst layer is stuck to the polymer electrolyte membrane.

In the case where the gas diffusion layer is used as the substrate, a filling (or sealing) layer may preliminarily be formed on the gas diffusion layer before the catalyst ink is coated. The filling (or sealing) layer is formed to prevent the catalyst ink from seeping into the gas diffusion layer. If the filling layer is preliminarily formed, the catalyst ink is accumulated on the filling layer and a three-phase boundary is formed even when a small amount of the catalyst ink is coated. Such a filling layer can be formed, for example, by dispersing carbon particles in a fluororesin solution and sintering the solution at a temperature higher than the melting point of the fluororesin. Polytetrafluoroethylene (PTFE) etc. can be used as the fluororesin.

A carbon separator and a metal separator etc. can be used as the separator in the present invention. The separator may incorporate the gas diffusion layer. In the case where the separator or the electrode catalyst layer also acts as the gas diffusion layer, it is unnecessary to arrange any separate gas diffusion layers. A fuel cell can be fabricated by joining additional equipment such as gas supply equipment and cooling equipment etc. to the MEA having the components described above.

### EXAMPLES

A specific example and comparative example of an MEA related to the present invention will be described below. The present invention, however, is not limited by the example below.

An example and comparative example are described.

### Example

### <Providing Conductivity Onto a Surface of a Catalyst>

Partially oxidized tantalum carbonitride (TaCNO, specific surface area: 9 m²/g) as a catalyst and a conductive polymer (polyethylenedioxythiophene (PEDOT) by TA Chemical Co.) as a conductive material are mixed together with a weight ratio of 1:0.05 so that a “catalyst provided with conductivity on the surface” was prepared.

### <Preparing a Catalyst Ink>

The “catalyst provided with conductivity on the surface”, carbon particles (Ketjen Black, product code: EC-300J, made by Lion Corporation, specific surface area: 800 m²/g) and a 20% by weight solution (solvent: IPA, ethanol and water) of a polymer electrolyte (Nafion®, made by DuPont) were mixed together in a solvent followed by performing a dispersion treatment using a planetary ball mill (product code: P-7, by Fritsch Japan Co., Ltd). A zirconia pot and zirconia balls were used for the ball mill. The resultant catalyst ink had 4:1 by weight composition ratio between the “catalyst provided with conductivity on the surface” and the carbon particles. In addition, the resultant catalyst ink had 0.8:1 by weight composition ratio between the polymer electrolyte and the carbon particles. A solvent mixture of 1:1 by volume of ultrapure water and 1-propanol was used as the solvent.

### <Forming an Electrode Catalyst Layer>

The catalyst ink was coated on a transfer sheet by a doctor blade and dried under atmosphere at 80° C. for five minutes. An electrode catalyst layer 2 for an air electrode was formed by adjusting the thickness in such a way that an amount of the catalyst which was loaded on the electrode catalyst layer in all was 0.4 mg/cm². A sheet of PTFE was used as the transfer sheet.

### Comparative Example

### <Preparing a Catalyst Ink>

A catalyst ink was prepared in the same way as in the Example described above except for providing the catalyst with conductivity on the surface.

### <Forming an Electrode Catalyst Layer>

The catalyst ink was coated on the transfer sheet and dried in the same way as in Example. An electrode catalyst layer 2 for an air electrode was formed by adjusting the thickness in such a way that an amount of the catalyst which was loaded on the electrode catalyst layer in all was 0.4 mg/cm².

### <<Forming an Electrode Catalyst Layer for a Fuel Electrode>>

An electrode catalyst layer for a fuel electrode is formed as described below in the Example and Comparative example. A catalyst of “platinum loaded carbon particles” (amount of loaded platinum: 50% by weight to the whole, product code: TEC10E50E, made by Tanaka Kikinzoku Kogyo K.K.) and a 20% by weight solution (solvent: IPA, ethanol and water) of a polymer electrolyte (Nafion®, made by DuPont) were mixed together in a solvent followed by performing a dispersion treatment using a planetary ball mill (product code: P-7, by Fritsch Japan Co., Ltd). The dispersion treatment was performed for 60 minutes. The resultant catalyst ink had a 1:1 by weight composition ratio between the carbons in the “platinum loaded carbon particles” and the polymer electrolyte. A solvent mixture of 1:1 by volume of ultrapure water and 1-propanol was used as the solvent. The resultant catalyst ink had a 10% by weight solid content. The catalyst ink was coated on a transfer sheet and dried in a similar way to the case of the electrode catalyst layer 2 for the air electrode. The electrode catalyst layer 3 for the fuel electrode was formed by adjusting the thickness in such a way that an amount of the catalyst which was loaded on the layer in all was 0.3 mg/cm².

### <<Fabricating a Membrane Electrode Assembly>>

The transfer sheet on which the electrode catalyst layer 2 for the air electrode was formed described in the Example and Comparative example and the transfer sheet on which the electrode catalyst layer 3 for the fuel electrode was formed described above were respectively stamped out in a shape of 5 cm² square and arranged facing both surfaces of a polymer electrolyte membrane (Nafion®212, made by DuPont). Subsequently, a hot pressing was performed at 130° C. for ten minutes to obtain an MEA 12. After arranging a pair of carbon cloths having a filler layer as gas diffusion layers on both surfaces, the resultant MEA 12 was further interposed between a pair of separators 10 so that a single cell of PEMFC or PEFC was fabricated.

### <<Power Generation Performance>>

### <Measurement>

Power generation performance was measured under a condition of 80° C. cell temperature and 100% RH (relative humidity) both in an anode and cathode using a fuel cell test apparatus GFT-SG1 made by Toyo Corporation. Pure hydrogen as a fuel gas and pure oxygen as an oxidant gas were used and controlled to flow at a constant rate. Back pressures on the anode (fuel electrode) side and the cathode (air electrode) side were 200 kPa and 300 kPa, respectively.

### <Result>

The MEA obtained in the Example had a lower resistance and improved performance than the MEA obtained in the Comparative example. This seems to be because the surface of the catalyst was sufficiently conductive due to the conductive polymer coated thereon.

What is claimed is:

1. A manufacturing method of an electrode catalyst layer for a fuel cell, comprising:
(1) preparing a “catalyst provided with electrical conductivity” by coating a first conductive material(s) on a surface of a catalyst;
(2) preparing a catalyst ink by dispersing said “catalyst provided with electrical conductivity”, a second conductive material(s), and a polymer electrolyte in a solvent; and
(3) coating said catalyst ink on a substrate to form said electrode catalyst layer,
wherein said substrate is one of the group of a gas diffusion layer, a transfer sheet and a polymer electrolyte membrane.

2. The manufacturing method according to claim 1, wherein said first conductive material(s) in (1) is a conductive polymer.

3. The manufacturing method according to claim 2, wherein in (1) a weight ratio of said first conductive material(s) is in the range of 0.01-30 with respect to 1 of said catalyst.

4. The manufacturing method according to claim 3, wherein the dispersion of said “catalyst provided with electrical conductivity”, said second conductive material(s), and said polymer electrolyte in said solvent in (2) is performed in such a way that carbon particles as said second conductive material(s) and said “catalyst provided with electrical conductivity” are preliminarily mixed without any solvent before said polymer electrolyte and said solvent are further added to prepare said catalyst ink.

5. The manufacturing method according to claim 4, wherein said catalyst contains at least one transition metal of the group of Ta, Nb, Ti and Zr.

6. The manufacturing method according to claim 5, wherein said catalyst is a product made by partially oxidizing a carbonitride of one transition metal of the group of Ta, Nb, Ti and Zr in the presence of oxygen.

7. The manufacturing method according to claim 6, wherein said one transition metal is Ta.

8. An electrode catalyst layer for a fuel cell, comprising:
a catalyst;
a second conductive material(s); and
a polymer electrolyte, wherein a first conductive material(s) is coated on at least a part of a surface of said catalyst.

9. The electrode catalyst layer according to claim 8, wherein said first conductive material(s) is a conductive polymer, and said second conductive material(s) is carbon particles.

10. The electrode catalyst layer according to claim 9, wherein a weight ratio of said first conductive material(s) is in the range of 0.01-30 with respect to 1 of said catalyst.

11. The electrode catalyst layer according to claim 10, wherein said catalyst contains at least one transition metal of the group of Ta, Nb, Ti and Zr.

12. The electrode catalyst layer according to claim 11, wherein said catalyst is a product made by partially oxidizing a carbonitride of one transition metal of the group of Ta, Nb, Ti and Zr in the presence of oxygen.

13. The electrode catalyst layer according to claim 12, wherein said one transition metal is Ta.

14. A membrane electrode assembly comprising:
a polymer electrolyte membrane;
a pair of electrode catalyst layers; and
a pair of gas diffusion layers, wherein each of said pair of electrode catalyst layers is the electrode catalyst layer according to claim 13, and wherein said polymer electrolyte membrane is interposed between said pair of electrode catalyst layers, and said pair of electrode catalyst layers are interposed between said pair of gas diffusion layers.

15. A fuel cell comprising:
the membrane electrode assembly according to claim 14; and
a pair of separators, wherein said membrane electrode assembly is interposed between said pair of separators.
